(19) United States
(12) Patent Application Publication
(10) Pub. No.: US 2008/0025249 A1
(43) Pub. Date: Jan. 31, 2008

(54) 1xEVDO WIRELESS INTERFACE TO ENABLE COMMUNICATIONS VIA A SATELLITE RELAY

(75) Inventors: Kalyan Kuppuswamy, San Diego, CA (US); June Namgoong, Chula Vista, CA (US); Srikant Jayaraman, San Diego, CA (US); Ahmad Jalali, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/829,869

(22) Filed: Jul. 27, 2007

Related U.S. Application Data
(60) Provisional application No. 60/820,775, filed on Jul. 28, 2006.

(51) Int. Cl. H04B 7/204

(52) U.S. Cl. 370/325

(57) ABSTRACT

A communication system is provided that allows a mobile terminal with an EVDO interface to perform VoIP communications via a satellite. The 1xEVDO physical layer frames and vocoder frames are synchronized and aligned to a known periodic time boundary for efficient transmission. A reverse link transmission rate is adjusted to match a VoIP packet source rate and operate the reverse link transmission channel to a satellite continuously. The reverse link transmission channel from a mobile terminal to a satellite may operate continuously and at a lower channel transmission rate to reduce the peak power amplifier power requirement. The higher layer time-out periods are increased to account for propagation delay to/from a satellite relay. A physical layer retransmit mechanism is disabled to ignore ACKs/NACKs when sending VoIP packets via a satellite relay. A different channel code may be selective applied depending on the size/type of packets being transmitted.

### CLAIM OF PRIORITY UNDER 35 U.S.C. §119

The present Application for Patent claims priority to Provisional Application No. 60/820,775 entitled “Satellite Based Communication”, filed Jul. 28, 2006 and assigned to the assignee hereof and hereby expressly incorporated by reference herein.

### BACKGROUND

1. Field

The present invention relates to wireless communications and, in particular, to a modified EVDO wireless interface to facilitate communications from a mobile terminal via a satellite relay.

2. Background

In many regions, wireless service to mobile terminals (e.g., mobile phones, etc.) is provided by a network of land-based access points (e.g., base stations). However, some regions (such as remote areas) may not have sufficient subscribers to justify the cost of deploying a network of land-based access points. In order to provide wireless service to mobile terminals in such regions, it would be advantageous to be able to communicate through a satellite network.

In other circumstances, even when a mobile terminal may be within a wireless service region, physical obstacles (such as mountains, canyons, buildings, etc.) may prevent signals from reaching the mobile terminal. However, in many such situations, the mobile terminal still may have line-of-sight access to satellites in the sky.

In yet other instances, due to natural disasters, sabotage, and/or power outages, land-based access points may be unavailable to provide wireless service to local mobile terminals.

Mobile terminals often have a limited power supply with which to operate and communicate. While such power supply is typically adequate to communicate with land-based access points, it is inadequate (or at best marginal) to communicate with a satellite located thousands of miles away. Additionally, existing satellite communication standards are not compatible with existing wireless communication standards for mobile terminals.

Therefore, there is a need for solutions that enable mobile terminals to communicate via satellites.

### SUMMARY

A first aspect provides for synchronizing a 1xEVDO physical layer frame and vocoder frame for more efficient transmission. That is, a physical layer frame and a vocoder frame are synchronized and then aligned with a known periodic time boundary, wherein the physical layer and vocoder frames are of different sizes.

A second aspect provides for adjusting a reverse link transmission rate to match a VoIP packet source rate and operate the reverse link transmission channel to a satellite continuously. The reverse link transmission channel from a mobile terminal to a satellite may operate continuously, rather than in cycles, at a lower channel transmission rate to reduce the peak power amplifier power requirement. The channel transmission rate is adjusted to match a VoIP packet source rate.

By synchronizing the vocoder frame and physical layer frame and adjusting the channel transmission rate, a mobile terminal is able to more efficiently transmit VoIP packets at the same rate that they are generated by the source (vocoder).

A third aspect provides for increasing the higher layer time-out periods to account for the propagation delay to/from a satellite relay.

A fourth aspect provides for the disabling a physical layer retransmit mechanism to ignore ACKs/NACKs on both the forward and reverse links when sending VoIP packets via a satellite relay since the large propagation delay precludes their use.

A fifth feature provides for selectively apply a different channel code depending on the size/type of packets being transmitted. For example, for the small VoIP packets (48 bits long in a 20 msec frame), a zero-overhead tailbiting convolutional code is employed. Meanwhile, larger packets may utilize a turbo code.

A mobile terminal is provided comprising a wireless communication interface, a vocoder, and/or a processor. The wireless communication interface may be configured to communicate via a satellite relay. In one example, the wireless communication interface is a modified Evolution-Data Optimize wireless communication interface. The vocoder may receive voice signals and digitizes them into VoIP packets. The processor may be configured to (a) obtain a voice signal; (b) digitize the voice signal into voice-over-IP (VoIP) packets; (c) synchronize a physical layer frame and a VoIP packet frame and align them with a known periodic time boundary, wherein the physical layer and VoIP packet frames are of different sizes; (d) transmit the VoIP packets over a reverse link channel to the satellite; (e) adjust a reverse link transmission rate to match a VoIP packet rate; (f) operate the reverse link transmission channel to the satellite continuously; (g) disable physical layer retransmit requests on the reverse link channel; and/or (h) selectively apply a different channel code depending on the size of packets being transmitted. In one implementation, a first code optimized for time sensitive payloads may be used to code payloads smaller than 128 bits and a different second code is used for payloads larger than or equal to 128 bits.

A method for communicating from a mobile terminal via a satellite relay is also provided, comprising: (a) obtaining a voice signal; (b) digitizing the voice signal into voice-over-IP (VoIP) packets; (c) synchronizing a physical layer frame and a VoIP packet frame and aligning them with a known periodic time boundary, wherein the physical layer and VoIP packet frames are of different sizes; (d) transmitting the VoIP packets over a reverse link channel to the satellite; (e) adjusting a reverse link transmission rate to match a VoIP packet rate; (f) operating the reverse link transmission channel to the satellite continuously; (g) disabling physical layer retransmit requests on the reverse link channel; (h) selectively applying a different channel code depending on the size of packets being transmitted; (i) selectively applying a different channel code depending on the type of packets being transmitted; (j) adjusting one or more time out periods in a communication protocol to account for the longer propagation delay over the satellite relay; and/or (k) providing an indication to a recipient that VoIP packets are to be transmitted. In one example, a first code optimized may be used for coding time sensitive payloads for payloads smaller than 128 bits and a different second code is used for payloads larger than or equal to 128 bits. For instance, a tailbiting convolutional code is used for the VoIP packets. The VoIP packets may be transmitted over a modified Evolution-Data Optimize wireless communication interface.

According to another novel feature, the method may further include providing an audible indication to the user that assist a user of the mobile terminal in orienting the mobile terminal to improve forward link signal reception from the satellite. In various implementations, the reverse link comprises: a Spread Spectrum Access Channel, flexible assignment of frequency channels, a rate set optimized for voice and for data, a broadband reverse link waveform, and/or a narrowband reverse link waveform. The reverse link may carry Channel Quality Indicator symbols generated using a bi-orthogonal code. The reverse link may use a partial tailbiting convolutional code as the reverse link channel code for the VoIP packets.

Consequently, a mobile terminal is provided comprising: (a) means for obtaining a voice signal; (b) means for digitizing the voice signal into voice-over-IP (VoIP) packets; (c) means for synchronizing a physical layer frame and a VoIP packet frame; (d) means for aligning the physical layer frame and a VoIP packet frame with a known periodic time boundary, wherein the physical layer and VoIP packet frames are of different sizes; (e) means for transmitting the VoIP packets over a reverse link channel; (f) means for adjusting a reverse link transmission rate to match a VoIP packet rate; (g) means for transmitting over the reverse link transmission channel continuously; (h) means for disabling physical layer retransmit requests on the reverse link channel; (i) means for selectively applying a different channel code depending on the type of packets being transmitted; and/or (j) means for adjusting one or more time out periods in a communication protocol to account for the longer propagation delay over a satellite relay.

A processor readable medium is also provided having one or more instructions for facilitating voice-over-IP communications, which when executed by a processor causes the processor to: (a) digitize a voice signal into voice-over-IP (VoIP) packets; (b) synchronize a physical layer frame and a VoIP packet frame and align them with a known periodic time boundary, wherein the physical layer and VoIP packet frames are of different sizes; (c) transmit the VoIP packets over a reverse link channel; (d) adjust a reverse link transmission rate to match a VoIP packet rate; (e) transmit over the reverse link transmission channel continuously; (f) disable physical layer retransmit requests on the reverse link channel; (g) selectively apply a different channel code depending on the type of packets being transmitted; and/or (h) adjust one or more time out periods in a communication protocol to account for the longer propagation delay over a satellite relay.

A processor is also provided comprising a processing circuit configured to (a) digitize a voice signal into voice-over-IP (VoIP) packets; (b) synchronize a physical layer frame and a VoIP packet frame and align them with a known periodic time boundary, wherein the physical layer and VoIP packet frames are of different sizes; (c) transmit the VoIP packets over a reverse link channel; (d) adjust a reverse link transmission rate to match a VoIP packet rate; (e) transmit over the reverse link transmission channel continuously; (f) disable physical layer retransmit requests on the reverse link channel; (g) selectively apply a different channel code depending on the type of packets being transmitted (h) adjust one or more time out periods in a communication protocol to account for the longer propagation delay over a satellite relay.

Another novel aspect proves a gateway for receiving voice-over-IP communications via a satellite relay, comprising: a wireless communication interface and a processor. The wireless communication interface may be configured to communicate via a satellite relay. The processor may be coupled with the wireless communication interface, and configured to (a) adjust a reverse link transmission rate to match a VoIP packet source rate and receive VoIP packets on the reverse link continuously; (b) receive VoIP packet frames that are smaller than physical layer frames, wherein a starting VoIP packet frame and a starting physical layer frame are synchronized and aligned to a known periodic time boundary, and the physical layer and VoIP packet frames are of different sizes; (c) receive an indication that VoIP packets will be received from the reverse link via the satellite relay; (d) disable physical layer retransmit requests on the reverse link channel; and/or (e) selectively use a different channel coding to receive on the reverse link channel depending on the type of packets being received. In one example, a first code optimized for time sensitive payloads may be used on payloads smaller than 128 bits and a different second code is used for payloads larger than or equal to 128 bits. The wireless communication interface may be a modified Evolution-Data Optimize wireless communication interface.

A method for facilitating voice-over-IP communications from a gateway via a satellite relay is also provided, comprising: (a) adjusting a reverse link transmission rate to match a VoIP packet source rate and receive VoIP packets on the reverse link continuously; (b) receiving VoIP packet frames that are smaller than physical layer frames, wherein a starting VoIP packet frame and a starting physical layer frame are synchronized and aligned to a known periodic time boundary, and the physical layer and VoIP packet frames are of different sizes; (c) receiving an indication that VoIP packets will be received from the reverse link via a satellite; (d) disabling physical layer retransmission requests; (e) selectively using a different channel coding to receive on the reverse link channel depending on the type of packets being received; and/or (f) adjusting one or more time out periods in a communication protocol to account for the longer propagation delay over the satellite relay. The VoIP packets may be received via a modified Evolution-Data Optimize (EVDO) wireless communication interface.

Consequently, a gateway is provided for receiving voice-over-IP communications via a satellite relay, comprising: (a) means for adjusting a reverse link transmission rate to match a VoIP packet source rate and receive VoIP packets on the reverse link continuously; (b) means for receiving VoIP packet frames that are smaller than physical layer frames, wherein a starting VoIP packet frame and a starting physical layer frame are synchronized and aligned to a known periodic time boundary, and the physical layer and VoIP packet frames are of different sizes; (c) means for receiving an indication that VoIP packets will be received from the reverse link via a satellite; (d) means for disabling physical layer retransmission requests; (e) means for selectively using a different channel coding to receive on the reverse link channel depending on the type of packets being received; (f) means for adjusting one or more time out periods in a communication protocol to account for the longer propagation delay over the satellite relay.

A processor readable medium is also provided having one or more instructions for facilitating voice-over-IP communications, which when executed by a processor causes the processor to (a) adjust a reverse link transmission rate to match a VoIP packet source rate and receive VoIP packets on the reverse link continuously; (b) receive VoIP packet frames that are smaller than physical layer frames, wherein a starting VoIP packet frame and a starting physical layer frame are synchronized and aligned to a known periodic time boundary, and the physical layer and VoIP packet frames are of different sizes; (c) receive an indication that VoIP packets will be received from the reverse link via a satellite; (d) disable physical layer retransmission requests; (e) selectively use a different channel coding to receive on the reverse link channel depending on the type of packets being received; and/or (f) adjust one or more time out periods in a communication protocol to account for the longer propagation delay over the satellite relay.

A processor is provided comprising a processing circuit configured to (a) adjust a reverse link transmission rate to match a VoIP packet source rate and receive VoIP packets on the reverse link continuously; (b) receive VoIP packet frames that are smaller than physical layer frames, wherein a starting VoIP packet frame and a starting physical layer frame are synchronized and aligned to a known periodic time boundary, and the physical layer and VoIP packet frames are of different sizes; (c) disable physical layer retransmission requests; (d) selectively use a different channel coding to receive on the reverse link channel depending on the type of packets being received; and/or adjust one or more time out periods in a communication protocol to account for the longer propagation delay over the satellite relay.

### BRIEF DESCRIPTION OF THE DRAWINGS

FIG. 1 illustrates a wireless communication system in which a mobile terminal may use a satellite to reach a land-based wireless communication network.

FIGS. 2 and 3 illustrate how frames from a vocoder may be synchronized with EVDO physical layer frames.

FIG. 4 illustrates how synchronized clocks periods may be utilized to align the start of vocoder and physical layer frames.

FIG. 5 illustrates a method operational on a mobile terminal to continuously transmit VoIP packets by synchronizing vocoder frames with EVDO physical layer frames.

FIG. 6 is a flow diagram illustrating a method operational on a sender of VoIP packets to match the transmission rate of a wireless interface to a source rate of VoIP packets to be transmitted.

FIG. 7 is a flow diagram illustrating a method operational on an EVDO communication interface to implement different types of channel coding depending on the type and/or size of packet to be transmitted.

FIG. 8 is a block diagram illustrating a mobile terminal with a modified EVDO communication interface that facilitates communications via a satellite relay.

FIG. 9 illustrates a method operational on a mobile terminal to facilitate VoIP packet transmissions via a satellite relay.

FIG. 10 is a block diagram illustrating a gateway configured to perform efficient communications with a mobile terminal via a satellite relay.

FIG. 11 illustrates a method operational on a gateway to facilitate VoIP packet transmissions via a satellite relay.

FIG. 12 illustrates the number of symbols that may be carried in a frame for different frequency assignments.

FIG. 13 illustrates an example of how 116 complex symbols may be arranged in time for a 20 ms frame occupying 6.5 kHz (symbol rate 5.8 kHz).

FIG. 14 illustrates an example of how a 20 ms frame occupying 26 kHz consists of 12 Pilot, 200 Data, 8 CQI, 24 Pilot, 8 CQI, 200 Data and finally 12 Pilot (symbol rate 23.2 kHz).

FIG. 15 illustrates one example of how the three bits of CQI may be encoded using a bi-orthogonal code.

FIG. 16 illustrates an example of the rate set optimized for Voice Traffic consists of payloads of N=40, 60 and 80 bits, conforming to the typical frame sizes generated by a vocoder algorithm over 20 ms.

FIG. 17 illustrates an example of modulation numerology for a Voice Rate Set with 6.5 kHz assignment.

FIG. 18 illustrates an example of modulation numerology for a Voice Rate Set with 13 kHz assignment.

FIG. 19 illustrates an example of modulation numerology for a Voice Rate Set with 26 kHz assignment.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine readable mediums for storing information. The term “machine readable medium” includes, but is not limited to portable or fixed storage devices, optical storage devices, wireless channels, and various other mediums capable of storing, containing, or carrying instruction(s) and/or data.

Furthermore, embodiments may be implemented by hardware, software, firmware, middleware, microcode, or a combination thereof. When implemented in software, firmware, middleware, or microcode, the program code or code segments to perform the necessary tasks may be stored in a machine-readable medium such as a storage medium or other storage means. A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, and the like, may be passed, forwarded, or transmitted via a suitable means including memory sharing, message passing, token passing, and network transmission, among others.

In order to provide improved service coverage to mobile terminals when other access points are unavailable or cannot be reached, it is desirable to allow the mobile terminals to communicate via satellites that relay communications with ground-based gateways. However, due to the great distances from a mobile terminal to an orbiting satellite, and the limited power available to the mobile terminal, achieving reliable VoIP communications is a challenge.

Evolution-Data Optimize (1xEV-DO, EV-DO or EVDO) is a telecommunications standard for the wireless transmission of data through radio signals. EVDO is commonly deployed on mobile terminals and provides fast packet establishment on both the forward and reverse links along with air interface enhancements that reduce latency and improve data rates. It may employ multiplexing techniques such as CDMA (Code division multiple access) as well as Frequency division duplex (FDD) to maximize the amount of data transmitted. However, in order to use an EVDO wireless interface to communicate with a satellite, some modifications are needed to the conventional implementation of EVDO.

A first aspect provides for synchronizing a 1xEVDO physical layer frame and vocoder frame for more efficient transmission. That is, a physical layer frame and a vocoder frame are synchronized and then aligned with a known periodic time boundary, wherein the physical layer and vocoder frames are of different sizes.

A second aspect provides for adjusting a reverse link transmission rate to match a VoIP packet source rate and operate the reverse link transmission channel to a satellite continuously. The reverse link transmission channel from a mobile terminal to a satellite may operate continuously, rather than in cycles, at a lower channel transmission rate to reduce the peak power amplifier power requirement. The channel transmission rate is adjusted to match a VoIP packet source rate.

By synchronizing the vocoder frame and physical layer frame and adjusting the channel transmission rate, a mobile terminal is able to more efficiently transmit VoIP packets at the same rate that they are generated by the source (vocoder).

A third aspect provides for increasing the higher layer time-out periods to account for the propagation delay to/from a satellite relay.

A fourth aspect provides for the disabling a physical layer retransmit mechanism to ignore ACKs/NACKs on both the forward and reverse links when sending VoIP packets via a satellite relay since the large propagation delay precludes their use.

A fifth feature provides for selectively apply a different channel code depending on the size/type of packets being transmitted. For example, for the small VoIP packets (48 bits long in a 20 msec frame), a zero-overhead tailbiting convolutional code is employed. Meanwhile, larger packets may utilize a turbo code.

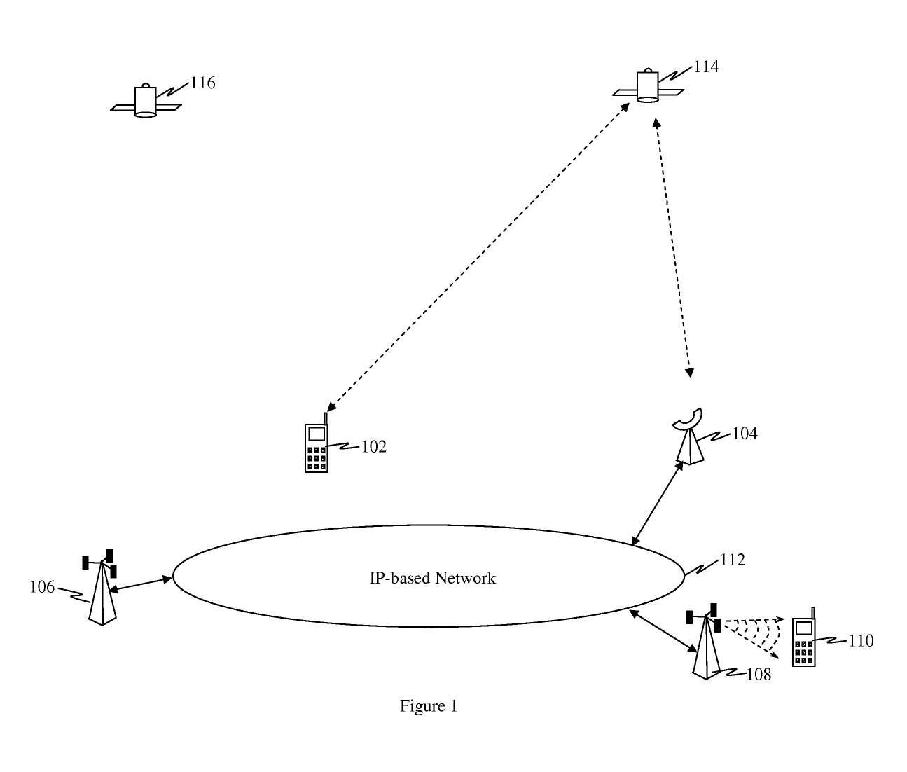

FIG. 1 illustrates a wireless communication system in which a mobile terminal may use a satellite to reach a land-based wireless communication network. The mobile terminal 102 (e.g., mobile communication device, mobile phone, wireless user terminal, etc.) may be configured to communicate with land-based access points 106 and 108 (such as base stations) that are coupled to an internet protocol (IP)-based network 112. The IP-based network 112 allows the mobile terminal 102 to communicate with other devices coupled to the network 112. For example, in one implementation, when the mobile terminal 102 is within reach of a first access point 106, it may utilize the first access point 106 to communicate with a second mobile terminal 110 via the IP-based network 112 and a second access point 108.

When the mobile terminal 102 is not within reach of an access point, it may be configured to use one or more satellites 114 and 116 to reach a gateway 104 to the IP-based network 112. For example, as illustrated, the mobile terminal 102 utilizes a first satellite 114 to reach the gateway 104 that is communicatively coupled to the IP-based network 112. In this manner, the mobile terminal 102 may reach other devices (such as the second mobile terminal 110) even when it is not within reach of an access point. In some applications, the mobile terminal 102 may be configured to utilize the satellite-based communication link as a preferred mode of operation instead of an access point.

Because of the distance from a mobile terminal to an orbiting satellite is often thousands of miles, the power available to a conventional mobile terminal may be insufficient to achieve reliable communications through a satellite. Thus, one or more modifications to an EVDO wireless interface and/or communication protocol are performed to facilitate the mobile terminal to communicate over a low-rate communication link (e.g., 2.4 Kbps reverse link rates) to the satellite.

### Synchronization of EVDO Physical Layer and Vocoder Frames

Under the 1xEVDO standard, a physical layer packet is transmitted in frames of 26.66 millisecond (msec) duration over a forward or reverse link. A typical EVDO physical layer frame (i.e., 26.66 msec) can comprise 16 slots, with each slot 1.66 msec in duration.

Many wireless communication systems digitize voice signals using a voice encoder (also known as a vocoder or voder) and transmit the digitized voice data as voice-over-IP (VoIP) packets. Typical vocoders may provide VoIP packets in frames of 20 msec duration (or 12 slots of 1.66 msec in duration). For each vocoder frame (20 msec duration), a vocoder may produce a VoIP packet 48 bits long (i.e., 40 bits of payload from vocoder and 8 bit checksum). Because the EVDO reverse link frame is 26.66 msec and the vocoder frame is 20 msec, this would imply that the VoIP packet would have to be padded to fit within the standard EVDO packet. However, adding padding to an EVDO physical layer frame is wasteful of the low-rate transmission channel between the mobile terminal and satellite.

EVDO also specifies fixed payload sizes of 128, 256, 512, 768 bits. These payloads are too large for efficient voice traffic where VoIP packets from the vocoder are 48 bits long. That is, it would be very wasteful of the limited power resources available to a mobile terminal to pad a 48 bit VoIP to satisfy a standard 128 EVDO payload size.

Therefore, in setting up a VoIP call session, one feature provides for using signaling from a transmitting mobile terminal to a receiving gateway to indicate that the payload sizes over the reverse link (from the mobile terminal to the gateway) will be 48 bits instead of one of the standard payload sizes (e.g., 128, 256, 512, or 768 bits). This smaller payload size accommodates the smaller VoIP packet size for more efficient communications.

Along with reducing the EVDO payload size, the vocoder frames are also synchronized with the EVDO physical layer frames to avoid the waste of having to pad the EVDO physical layer frames. By synchronizing vocoder and physical layer frames, constant transmissions over the reverse link from the mobile terminal may be maintained.

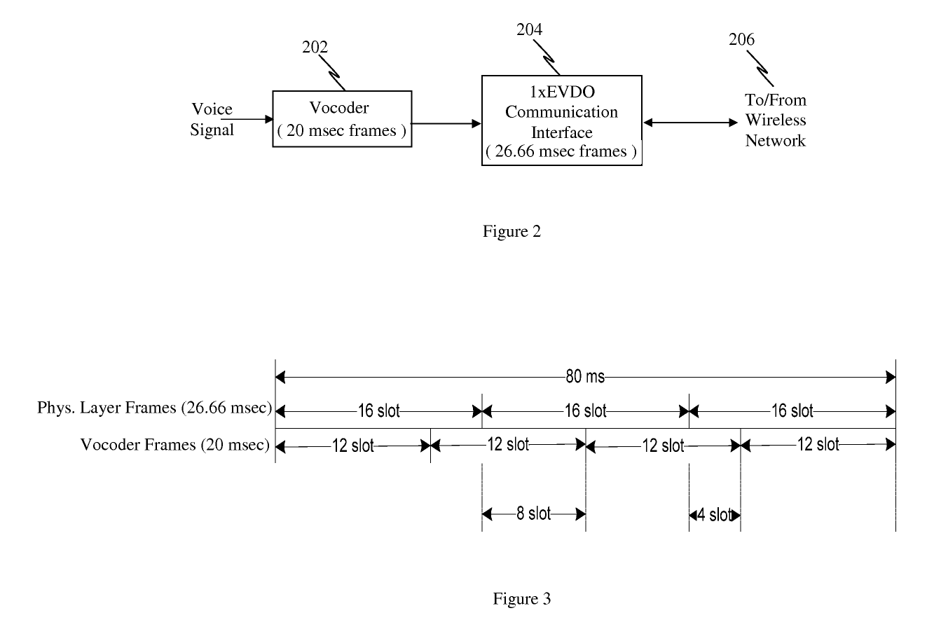

FIGS. 2 and 3 illustrate how frames from a vocoder may be synchronized with EVDO physical layer frames. A mobile terminal may include a vocoder 202 to receive voice signals, digitize the signal, and provide VoIP packets (e.g., 48 bits long) in 20 msec frames. The mobile terminal may also include a 1xEVDO communication interface 204 that communicates with a wireless network 206 (e.g., to/from a satellite or gateway). FIG. 3 illustrates how the vocoder frames (20 msec) and EVDO physical layer frames (26.66 msec) may be synchronized on 80 msec boundaries. Each 16 slot represents a 26.66 msec frame (EVDO physical layer) and each 12 slot represents a 20 msec frame (vocoder). The mobile terminal aligns the start of a 20 msec vocoder frame with the start of a 26.666 msec EVDO physical layer frame. Once this is done, every fourth 20 msec vocoder frame automatically aligns with 26.666 msec boundaries of an EVDO physical layer frame. The 80 msec window accommodates three (3) EVDO frames (26.6. msec each) and four (4) vocoder frames (20 msec) along natural alignment boundaries.

The receiving gateway can synchronize to 20 msec frame boundaries by testing no more than three different hypotheses. That is, the receiving gateway can attempt to detect the vocoder frames at each of three consecutive EVDP physical layer frame boundaries. The synchronization by the mobile terminal guarantees that the start of a vocoder frame will be detected at one those boundaries.

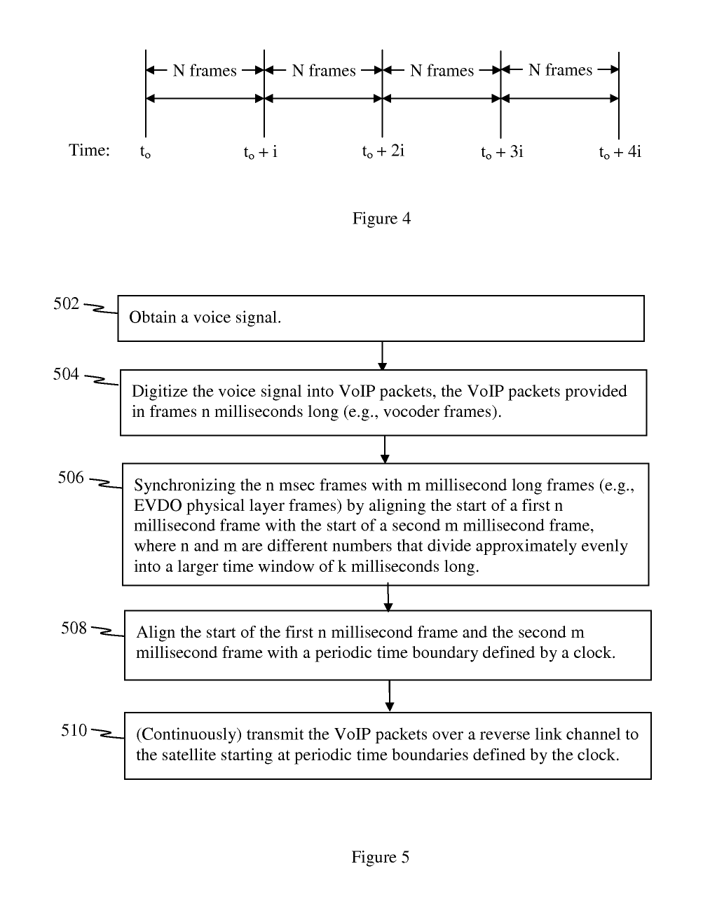

Such boundary testing at the gateway may be avoided if, additionally, the gateway and mobile terminal have synchronized time boundaries. For example, the gateway may synchronize its clock from the wireless network clock or a global positioning system (GPS) clock, for example. The gateway sends timestamps to mobile terminal which uses it to synchronize its own internal clock. Having synchronized their internal clocks, the mobile terminal and gateway may align the start of their frames to specified clock periods or epochs. FIG. 4 illustrates how synchronized clocks periods may be utilized to align the start of vocoder and physical layer frames. For instance, both the mobile terminal and gateway may be configured to expect N frames in a period of i seconds, where N frames provides a natural boundary for both vocoder frames and EVDO physical layer frames. That is, the mobile terminal may start its frames so that they coincide with particular periodic time boundaries (i.e., tₒ, tₒ+i, tₒ+2i, tₒ+3i, etc.). Similarly, the gateway can expect to receive frames starting at those same boundaries. For example, periods/epochs that start exactly every two (2) seconds may be selected. Thus, the mobile terminal may align transmission frames at those two second boundaries (e.g., tₒ, tₒ+i, tₒ+2i, tₒ+3i, etc.). Similarly, the gateway should expect to receive the start of a new frame on such two second boundaries. In a two second period, seventy-five (75) 26.66 msec physical layer frames (or one hundred (100) 20 msec vocoder frames) may be transmitted. Since the 26.666 msec and 20 msec frame boundaries also coincide with the two second periods/epochs, this extra restriction completely specifies the relative phase of 20/80 msec frame boundaries.

FIG. 5 illustrates a method operational on a mobile terminal to continuously transmit VoIP packets by synchronizing vocoder frames with EVDO physical layer frames. A voice signal from a phone call is obtained 502. The voice signal is digitized into VoIP packets, the VoIP packets provided in frames n milliseconds long 504 (e.g., vocoder frames), where n milliseconds may be 20 msec, for example.

The n msec frames are synchronized with m millisecond long frames (e.g., EVDO physical layer frames) (where m may be 26.66, for example) by aligning the start of a first n millisecond frame with the start of a second m millisecond frame, where n and m are different numbers that divide approximately evenly into a larger time window of k milliseconds long (e.g., 80 millisecond long window) 506. That is, whole numbers of n and m millisecond frames fit within the larger k millisecond window.

506. The start of the first n millisecond frame and the second m millisecond frame are also aligned with a periodic time boundary defined by a clock (e.g., a mobile terminal clock synchronized to a gateway clock). For example, the periodic time boundaries may fall on even number seconds (i.e., 2, 4, 6, 8, 10 . . . ). The VoIP packets are then (continuously) transmitted over a reverse link channel to the satellite starting at periodic time boundaries defined by the clock 510.

### Continuous Transmissions Over Reverse Link Channel to Reduce Peak Power

Currently, transmissions over a 1xEVDO reverse link (RL) traffic channel occur in bursts or on a duty cycle less than 100%. The lowest traffic channel rate for a 1xEVDO reverse link (RL) traffic channel is 4.8 kbps but runs at 9.6 kbps peak over half the time. However, a mobile terminal may be peak power limited (when trying to communicate with a satellite) so it does not help to transmit at duty cycles less than 100%.

Rather than operating at peak power in burst or a duty cycle less than 100%, the reverse link transmits continuously at a reduced rate of 2.4 kbps at the highest power possible. This allows matching the transmitted payload (e.g., 48 bits in a 20 msec frame) to the vocoder frame size (20 msec).

Using the lowest standard EVDO traffic rate of 4.8 kbps, the 2.4 kbps of VoIP data produced by the vocoder could be combined into 4.8 kbit payloads and transmitted only half the time. Such transmissions at peak power on a 50% duty cycle require twice as much peak power in comparison to continuous transmissions at 2.4 kbps. Consequently, when transmitting VoIP packets (48 bit payloads on 20 msec frames), it is better to modify the operation of the conventional EVDO interface to transmit continuously at 2.4 kbps. The average power utilized by the continuously transmitting at 2.4 kbps is the same as the 50% duty cycle transmissions at 4.8 kbps, but consumes less peak power than transmitting at 4.8 kbps.

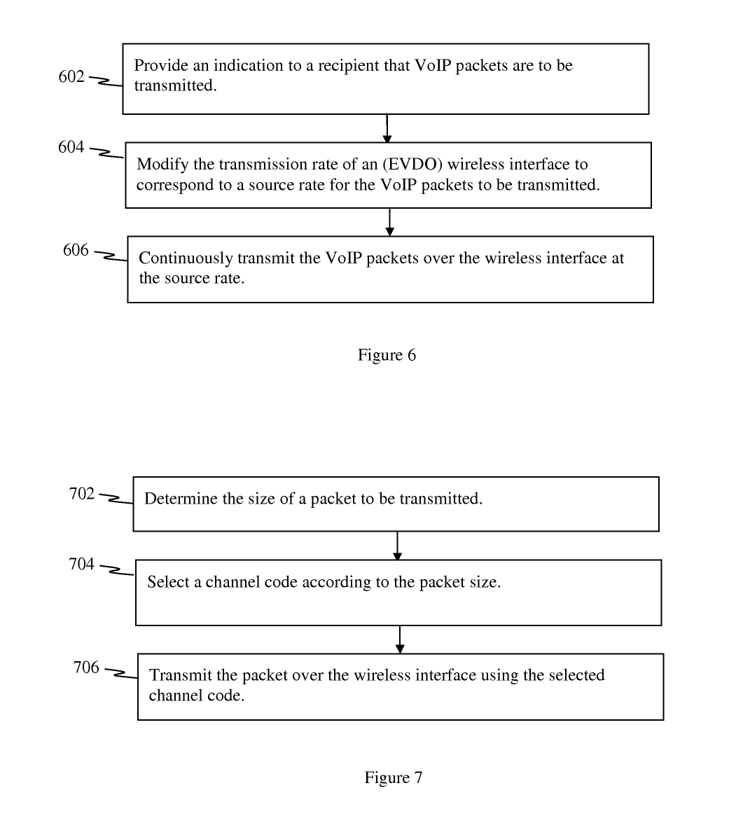

FIG. 6 is a flow diagram illustrating a method operational on a sender of VoIP packets to match the transmission rate of a wireless interface to a source rate of VoIP packets to be transmitted. The sender (e.g., mobile terminal) may provide an indication to a recipient (e.g., gateway) that VoIP packets are to be transmitted 602. This allows the intended recipient (e.g., gateway) to modify its receiver to receive VoIP packets at a predefined rate (e.g., 2.4 kbps for a vocoder source operating at 2.4 kbps). The sender then modifies its transmission rate of a (EVDO) wireless interface to correspond to a source rate for the VoIP packets to be transmitted 604. For example, for a vocoder providing VoIP packets at 2.4 kbps (e.g., 48 bits every 20 msec), the transmission rate of an EVDO wireless interface may be reduced to 2.4 kbps. The VoIP packets can then be continuously transmitted over the wireless interface at the source rate 606. This method allows using a packet payload that fits within source payload and framing within what the VoIP source is producing.

### Time Out Period and Search Window Adjustment

Another consideration in implementing communications between a mobile terminal and a gateway via a satellite is the propagation delay resulting from the long distance to and from the satellite.

A Time Out period is often specified in communication protocols to define the maximum amount of time to wait prior to retrying or terminating communications. That is, if an expected response or message is not received within the Time Out period, a device may try resending information or dropping a communication link. Because of the longer-than-usual propagation delays resulting from communicating via a satellite, the Time Out period is increased at both the mobile terminal and gateway. For example, the Time Out period may be increased from a standard few milliseconds to several hundred milliseconds depending on the distance to the satellite. For an EVDO system, specific timeouts that may be modified to account for geo-satellite delays include the following.

The following Signaling link protocol (SLP) timers may be modified to accommodate the satellite link delay.

T_{SLPAck} Timer: This is a timer for the receiver to acknowledge an arriving reliable-delivery SLP-D packet. The default value for this timer is 200 ms; it may be modified to 1000 msec (or some larger value) to accommodate the geo-satellite delay.

T_{SLPAck} Timer: This is a retransmission timer for a reliable-delivery SLP-D packet. The default value for this timer is 400 ms; it may be modified to 1000 msec ((or some larger value) to accommodate the geo-satellite delay.

The following Radio Link Protocol (RPL) timers may be modified to accommodate the satellite link delay.

T_{RLPAbort} Timer: This is a timer to wait for a retransmission of an octet requested in a NAK message. This is a public data that is sent over-the-air by the Base Station to the ATs as part of 1xEV-DO Rev. A session configuration/GAUP procedures. The default value for this timer is 500 ms; it has been modified to 1000 ms to accommodate the geo-satellite delay.

T_{RLPFlush} Timer: This is a timer to wait before retransmitting the last transmitted octet. This is a public data that is sent over-the-air by the Base Station to the ATs as part of 1xEV-DO Rev. A session configuration/GAUP procedures. The default value for this timer is 300 ms; it has been modified to 1000 ms to accommodate the geo-satellite delay.

The Access Probe Timers for Access Channel Protocol may also be modified. The IntraProbeBackOff parameter (time between consecutive probes) and InterSequenceBackOff parameter (time between consecutive probe sequences) may be adjusted to accommodate the geo-satellite delay. The default value for IntraProbeBackOff is 128 slots (1slot=1.66 ms) and may be modified to 512 slots (or some larger value). The default value for InterSequenceBackOff is 128 slots and may be modified to 512 slots (or some larger value).

### Disable Physical Layer Retransmit Requests

The EVDO standard provides a retransmission system at the physical layer. That is, EVDO has a retransmit channel where it sends physical layer ACKs/NACKs (also known as ARQ requests) to indicate the receipt (ACK) or none receipt (NACK) of physical layer frames. This mechanism allows a sender to indicate when information has been successfully decoded even before the whole packet has been received. For instance, because standard EVDO packets are turbo coded, a receiver may be able to decode the whole packet from just a fraction of the transmission (e.g., the first 5 msec of a frame). This may allow the receiver to send an ACK to the sender to acknowledge receipt of the information even before the sender transmits the whole frame. This facilitates efficient use of a reverse link since the sender can terminate a frame transmission if an ACK has been received for that frame. This works because the propagation delays in land-based wireless systems are small (e.g., 2 msec) in comparison to the transmission frames (e.g., 20 msec for VoIP frames).

However, in communications from a mobile terminal via a satellite, the propagation delays are typically longer than the VoIP frames (e.g., 20 msec). Because of large round trip delay when communicating via a satellite relay, the EVDO physical layer ACK/NACK are not useful. By the time an ACK/NACK was received, the frame would have been transmitted. Therefore, along with modifying the EVDO physical layer framing, the retransmit mechanism is disabled. So the mobile terminal may be configured to ignore ACKs/NACK on the forward link and not send ACKs/NACKs on the reverse link.

Instead, the communication system may rely on higher level retransmit requests to resend data when necessary. Link level reliability may be provided via the Radio Link Protocol (RLP) which has procedures to detect missing MAC fragments and retransmit them.

### Packet Size/Data Dependent Channel Coding

The EVDO standard defines the use of turbo code as the channel code for all data packets. However, such turbo codes add significant overhead and are better for larger payload sizes (e.g., 128 bits, 256 bits, etc.). For VoIP payloads that are only 48 bits long, use of a turbo code is inefficient.

Therefore, the EVDO communication interface may be configured to use different convolutional codes depending on the payload size. For VoIP packets (48 bit payloads) or small delay-sensitive packets, a low or zero-overhead tailbiting convolutional code may be used, while larger data packets (or best-effort packets) may use a turbo code. For example, tailbiting coding may be used for VoIP packets since it is optimized for small packets while turbo coding may be used for larger packets. Consequently, the EVDO interface may be configured to use different coding depends on packet type. The use of low-overhead tailbiting convolutional coding for VoIP packets may provide a significant power savings over using a larger overhead turbo code.

FIG. 7 is a flow diagram illustrating a method operational on an EVDO communication interface to implement different types of channel coding depending on the type and/or size of packet to be transmitted. The size of a packet to be transmitted is determined 702. Alternatively, the type of packet (e.g., VoIP) packet may be determined. A particular channel code is selected according to the packet size or type 704. For example, for a VoIP packet (48 bits long per frame) a tailbiting code may be used, while for a data packet (e.g., 256 bits long) a turbo code may be used. The packet is then transmitted over the wireless interface using the selected channel code 706.

FIG. 7 is a flow diagram illustrating a method operational on an EVDO communication interface to implement different types of channel coding depending on the type and/or size of packet to be transmitted. The size of a packet to be transmitted is determined 702. Alternatively, the type of packet (e.g., VoIP) packet may be determined. A particular channel code is selected according to the packet size or type 704. For example, for a VoIP packet (48 bits long per frame) a tailbiting code may be used, while for a data packet (e.g., 256 bits long) a turbo code may be used. The packet is then transmitted over the wireless interface using the selected channel code 706.

### Example of Mobile Terminal

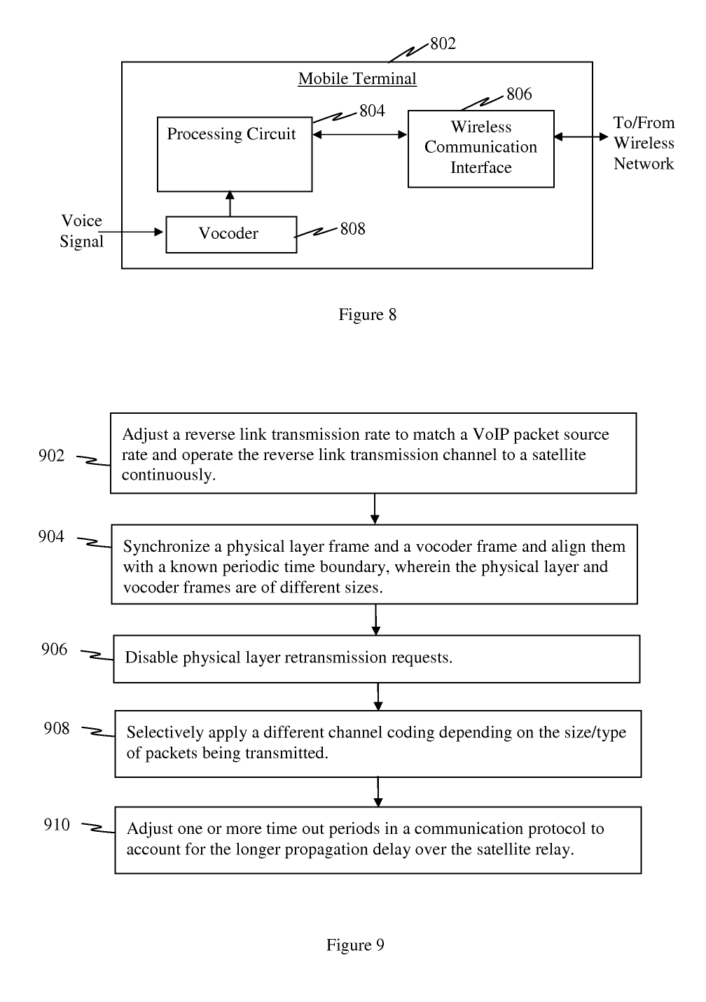

FIG. 8 is a block diagram illustrating a mobile terminal with a modified EVDO communication interface that facilitates communications via a satellite relay. In this example, the mobile terminal 802 may include a processing circuit 804 coupled to a wireless communication interface 806 to communicate over a wireless network and a vocoder 808 to digitize voice signals. The wireless communication interface 806 may communicate with an IP-based network through either land-based access points (e.g., base stations) and/or satellites that communicate with land-based gateways. The wireless communication interface 806 may be configured to efficiently transmit VoIP packets (e.g., 48 bits in 20 msec frames) over a low-rate communication link (e.g., 2.4 kbps) via satellite). VoIP packet frames from the vocoder 808 may be synchronized with the EVDO physical layer frames (in communication interface 806) to achieve greater transmission efficiency. Additionally, the mobile terminal 802 may be configured to operate according to one or more of the novel features described herein.

FIG. 9 illustrates a method operational on a mobile terminal to facilitate VoIP packet transmissions via a satellite relay. For VoIP packet communications, a reverse link transmission rate may be adjusted to match a VoIP packet source rate and the reverse link transmission channel to a satellite is operated continuously 902. The link may operate at a lower than normal transmission rate (e.g., transmit at 2.4 kbps instead of the nominal rate of 4.8 kbps for EVDO interfaces) to match to vocoder rate (e.g., 2.4 kbps). The start of 1xEVDO physical layer frames and vocoder frames may be synchronized and aligned with a known periodic time boundary (known to both the sender and receiver), wherein the physical layer and vocoder frames are of different sizes 904. To reduce unnecessary traffic, an 1xEVDO interface physical layer retransmission request mechanism is disabled 906. The mobile terminal may also selectively apply a different channel coding depending on the size/type of packets being transmitted 908. Additionally, one or more time out periods in a communication protocol may be adjusted to account for the longer propagation delay over the satellite relay 910.

### Example of Gateway

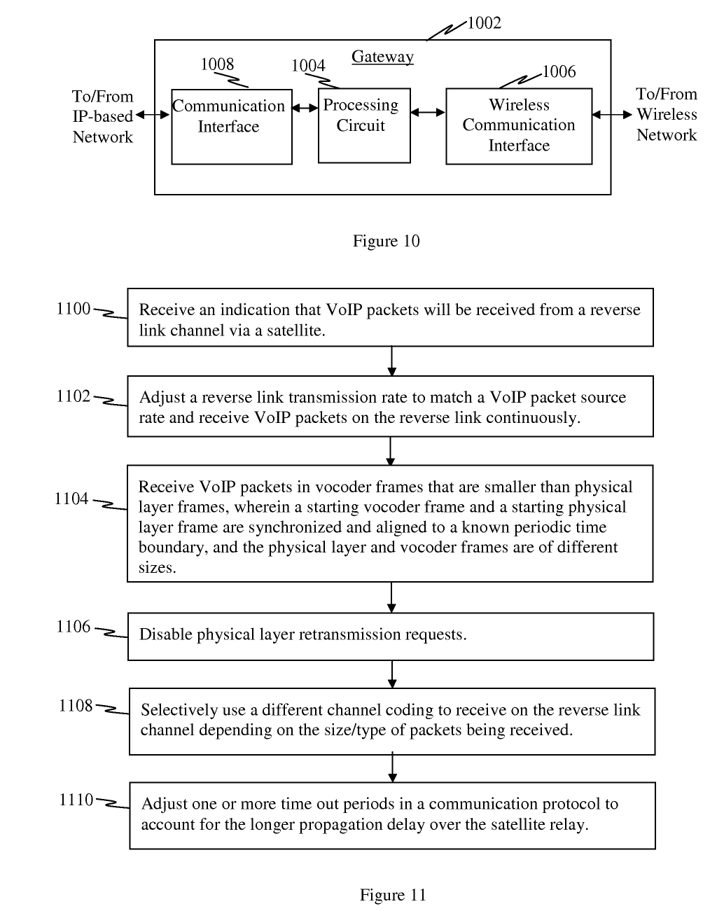

FIG. 10 is a block diagram illustrating a gateway configured to perform efficient communications with a mobile terminal via a satellite relay. In this example, the gateway 1002 may include a processing circuit 1004 coupled to a wireless communication interface 1006 to communicate over a wireless network and a second communication interface 1008 to communicate over an IP-based network. The wireless communication interface 1006 may be a modified EVDO interface that communicates with a mobile terminal via a satellite relay over a low-rate communication link. Consequently, the gateway 1002 may receive VoIP packets from the second communication interface 1008, process them for efficient transmission over the satellite relay, and transmit them over the wireless communication interface 1006. Conversely, the gateway 1002 may receive VoIP packets from the wireless communication interface 1006, process the VoIP packets, and transmit the VoIP packets over the second communication interface 1008. The mobile terminal 1002 may be configured to operate according to one or more of the novel features described herein.

FIG. 11 illustrates a method operational on a gateway to facilitate VoIP packet transmissions via a satellite relay. The gateway may receive an indication that VoIP packets will be received from a reverse link channel via a satellite 1100. This may allow the gateway to adjusts its communication interface accordingly. The gateway may adjust a reverse link transmission rate to match a VoIP packet source rate (at the mobile terminal) and receive VoIP packets on the reverse link continuously 1102. The link may operate at a lower than normal transmission rate (e.g., transmit at 2.4 kbps instead of the nominal rate of 4.8 kbps for EVDO interfaces). The gateway may then receive VoIP packets in vocoder frames that are smaller than physical layer frames, where a starting vocoder frame and a starting physical layer frame are synchronized and align to a known periodic time boundary, wherein the physical layer and vocoder frames are of different sizes 1104. Physical layer retransmission requests may be disabled 1106. Different channel coding may be used to receive on the reverse link channel depending on the size/type of packets being received 1108. Additionally, one or more time out periods in a communication protocol may be adjusted to account for the longer propagation delay over the satellite relay 1110.

### User-Assisted Satellite Signal Search

One difficulty with utilizing a satellite relay is that satellite signal reception at a mobile terminal may be affected by the position of the mobile terminal. Thus, another novel feature provides a mechanism by which the mobile phone is assisted by the user in searching for a mobile terminal position and/or direction which provides the best service. In particular, the orientation and/or direction of the mobile terminal antenna may affect the quality of reception of a forward link signal from a satellite.

In implementation, the mobile phone may be configured to provide audible and/or graphic feedback to the user indicating the relative strength of signal reception. For example, as a user changes the position, orientation, and/or direction of the mobile terminal (e.g., mobile phone) a sequence of audio tones, beeps, etc., may indicate a relative improvement or worsening of signal reception from a satellite with which the mobile terminal communicate. Similarly, a display screen on a mobile terminal may be used to indicate an improvement or worsening of a satellite signal. The mobile device may compare signal strength, signal to noise ratios, or other characteristics in determining whether the satellite signal is better or worse.

### Reverse Link Channel

In various implementations, the reverse link from the mobile terminal to the satellite may be implemented across broadband and narrowband channels in the frequency spectrums.

In one example, a “narrowband” FDMA physical layer is used for the reverse link. The 1.25 MHz of transmit spectrum is divided into approximately 192 narrowband frequency channels with a bandwidth of 6.5 kHz, and users are assigned one or more individual channels depending primarily on channel availability and “system load”. Typically no two users within a beam are assigned the same frequency channel and, as a result, users within a beam do not interfere with each other. Such a design offers greater link margin than a CDMA approach. In various examples, the reverse link may be implemented using a Spread Spectrum Access Channel, a Flexible Assignment of Frequency Channels, and/or Rate Sets optimized for Voice and for Data.

Spread Spectrum Access Channel: Users may initiate calls using a low-rate (2.4 kbps) spread spectrum access channel. Since the access channel is spread across 1.25 MHz, access transmissions degrade equally all narrowband frequency channels. Furthermore, access channel capacity can be increased, if necessary, without reducing voice capacity by simply adding parallel spread spectrum access channels with different long-code masks. Additional access channels slightly degrade link margin by increasing the background interference density. Of course, additional access channels require increased search resources at the gateway because every potential access attempt must be searched.

Flexible Assignment of Frequency Channels: Typically a user with a small phone can only transmit at rates ranging from 2.4-4.8 kbps while maintaining adequate link margin. For such a user, a transmission bandwidth larger than about 6.5 kHz affords negligible benefit. On the other hand, a user with a large phone who can tolerate greatly reduced link margin might be able to transmit at rates as high as 19.2-38.4 kbps. Forcing such a user to transmit within a 6.5 kHz bandwidth is inefficient. In fact, it can be about 1-2 dB more efficient from a coding and modulation view if such a user spread his transmit power over a larger band. Accordingly, the system design offers flexible frequency assignments in multiples of 6.5 kHz, namely in chunks of 6.5 kHz, 13 kHz, and 26 kHz. If a user believes he has adequate transmit power and margin to exploit a larger frequency assignment, he can make such a request during the access process. Depending on the system load, his request may or may not be granted. For example, if the system is lightly loaded with many available frequency channels, he may be allowed a bandwidth of, say, 13 or 26 kHz. On the other hand, if frequency channels are scarce, his request might be denied and he may be allowed only a 6.5 kHz channel.

Rate Sets optimized for Voice and for Data: Separate rate sets are used for transmitting low bit-rate voice with tight delay restrictions, and for transmitting best-effort packet data. In the former case, the rate sets are optimized for small payloads (40, 60 or 80 bits), and use efficient tailbiting convolutional codes. The natural transmission duration here is 20 ms. On the other hand, for best-effort packet data, there are no restrictions on the payload size and/or the natural frame duration. With a minimum payload size of 128 bits and transmission durations of 40/80 ms, turbo coding can be employed which is more efficient than convolutional codes for larger payloads.

### Example Reverse Link Frame Structure

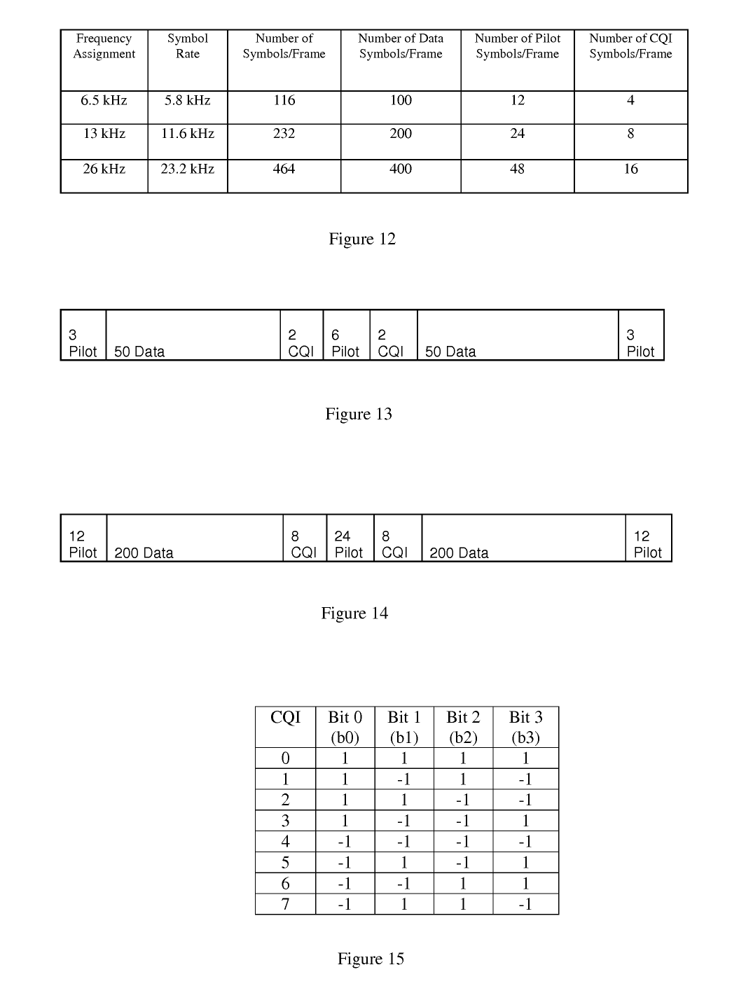

Reverse link frames have a duration of 20 ms. Each frame carries pilot symbols, data symbols, and Channel Quality Indicator (CQI) symbols, and the number of symbols in each frame depends on the frequency assignment. For example, FIG. 12 illustrates the number of symbols that may be carried in a frame for different frequency assignments. For example, with a frequency assignment of 6.5 kHz, a frame consists of 116 complex (I/Q) symbols over a 20 ms duration translating to a symbol rate of 5.8 kHz. The 116 complex symbols modulate a root raised-cosine pulse with 12% excess bandwidth, so the bandwidth occupied by the transmitted waveform is approximately 5.8×1.12=6.5 kHz. FIG. 13 illustrates an example of how 116 complex symbols may be arranged in time for a 20 ms frame occupying 6.5 kHz (symbol rate 5.8 kHz). In other words, a 20 ms frame occupying 6.5 kHz consists of 3 Pilot symbols, followed by 50 Data symbols, 2 CQI symbols, 6 Pilot symbols, 2 CQI symbols, 50 Data symbols, and finally 3 Pilot symbols. By contrast, FIG. 14 illustrates an example of how a 20 ms frame occupying 26 kHz consists of 12 Pilot, 200 Data, 8 CQI, 24 Pilot, 8 CQI, 200 Data and finally 12 Pilot (symbol rate 23.2 kHz). In fact, the main difference between the two cases illustrated in FIGS. 13 and 14 is that the duration of each symbol has been reduced by a factor of four, but the number of symbols has been correspondingly quadrupled. The overall duration of the pilot bursts, data bursts and CQI bursts remains invariant.

### Reverse Link Channel Quality Indicators

Pilot Symbols and CQI symbols may be transmitted by the mobile terminal at maximum power (or a suitably high, constant fraction of maximum power). The noisy Pilot Symbols received by the gateway are used to estimate the maximum signal-to-interference-and-noise ratio (SINR) achievable on the reverse link, or equivalently, the maximum reverse link data rate that can be achieved if the mobile terminal were to transmit the Data Symbols at maximum power. This maximum data rate plays the role of “reverse link CQI”. The gateway transmits the reverse link CQI to each mobile terminal on the forward link in place of the CDMA Reverse Power Control (RPC) bit. The transmissions to different mobile terminals are Walsh multiplexed using the terminal's MAC indices, in a manner similar to transmission of the RPC bits in 1xEV-DO Rev A.

Based on the reverse link CQI history, the mobile terminal is able to decide on the maximum data rate that is feasible for transmission on the reverse link. If the mobile terminal wishes to transmit at the maximum feasible data rate, it transmits the Data Symbols at maximum power. On the other hand, if the mobile terminal selects a data rate that is lower than the maximum feasible data rate, it may transmit the Data Symbols at a reduced power level. The possible reduction in power may be computed using a fixed table which exploits the known relationship between the SINR's needed to achieve the different rates on the reverse-link.

### Generation of Reverse Link Channel Quality Indicator (CQI) Symbols

In each 20 ms frame on the reverse link, the mobile terminal may transmit three bits worth of “Channel Quality Indication” (CQI) to tell the gateway the data rate it is capable of receiving on its forward link. The three bits of CQI can be used to indicate one of eight different forward link rates. FIG. 15 illustrates one example of how the three bits of CQI may be encoded using a bi-orthogonal code. The four bi-orthogonal code bits (b0, b1, b2 and b3) are BPSK-modulated using the standard BPSK mapping: BPSK(b)=1−2b.

For a 6.5 kHz frequency assignment, the four BPSK modulated symbols are mapped sequentially to the four symbols of CQI in the corresponding frame structure illustrated in FIG. 13. For the 13 kHz frequency assignment, each BPSK symbol is repeated once to yield (BPSK(b0), BPSK(b0), BPSK(b1), BPSK(b1), . . . , BPSK(b3), BPSK(b3)), then mapped sequentially to eight symbols of CQI in the corresponding frame structure. For the 26 kHz frequency assignment, each BPSK symbol is repeated three times (analogous to the 13 kHz case), then mapped to sixteen symbols of CQI in the corresponding frame structure illustrated in FIG. 14.

Note that an entire CQI codeword is transmitted in each 20 ms frame. Since the coding gain for the CQI transmission is not large, the gateway should look at a recent history of CQI transmissions (˜250 ms) in order to decide on the rate to serve a user on the forward link. Such a time-span is acceptable because CQI is expected to vary only slowly due to path-loss variations and similar long-term effects.

### Rate Set for Voice Traffic

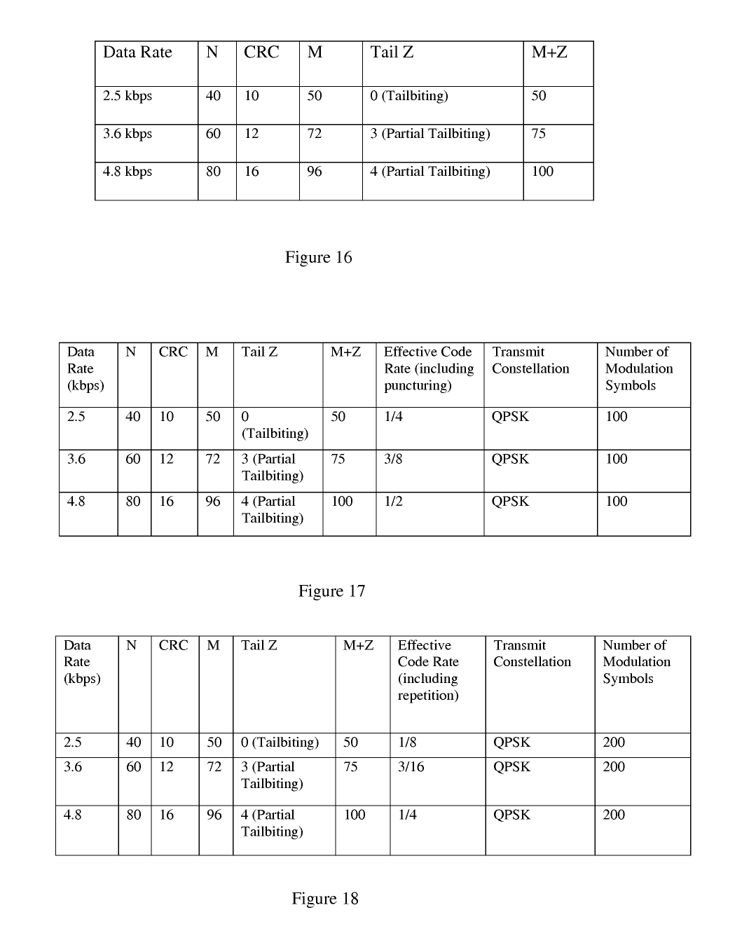

FIG. 16 illustrates an example of the rate set optimized for Voice Traffic consists of payloads of N=40, 60 and 80 bits, conforming to the typical frame sizes generated by a vocoder algorithm over 20 ms. A 10, 12, and 16 bit CRC is appended to the 40, 60 and 80 bit payloads, respectively, using one of the following polynomials listed below. The resulting frame has size M=50, 72, or 96 bits.

$$\begin{matrix}g ( x ) = {x}^{10} + {x}^{9} + {x}^{8} + {x}^{7} + {x}^{6} + {x}^{4} + {x}^{3} + 1 , & 10 \text{-} bit CRC \\ g ( x ) = {x}^{12} + {x}^{11} + {x}^{10} + {x}^{9} + {x}^{8} + {x}^{4} + x + 1 , & 12 \text{-} bit CRC \\ g ( x ) = {x}^{16} + {x}^{15} + {x}^{14} + {x}^{11} + {x}^{6} + {x}^{5} + {x}^{2} + x + 1 , & 16 \text{-} bit CRC\end{matrix}$$

The M-bit frame is then encoded using a rate ¼, maximum free distance convolutional code of constraint length 11. The generator polynomial of the code in octal form is given by:

G=(4656,4726,5562,6372).

The encoding is performed using “tailbiting” or “partial tailbiting” to eliminate or reduce the need for encoder tail bits. In tailbiting mode, the encoder shift-registers are initialized with the last 10 bits in the M-bit frame, before the bits are clocked in. At the k-th clock, the four encoder output bits are labeled c(0,k), c(1,k), . . . , c(3,k) where k=0, . . . , M−1. In partial tailbiting mode, Z zeros are appended to the M-bit frame to yield a frame of length M+Z. The encoder shift-registers are initialized with the last 10 bits in the M+Z-bit frame. The M+Z bits are then clocked into the encoder and the output bits at the k-th clock are labeled c(0,k), c(1,k), . . . , c(3,k) where k=0, . . . ,M+Z−1.

The encoder output bits are punctured/repeated/modulated differently depending on the frequency assignment. The procedures are described in the following subsections. Depending on the frequency assignment, the different procedures yield 100, 200 or 400 modulation symbols, which are transmitted over a single 20 ms frame. Together with the definitions of the Pilot and CQI Symbols, this completely defines the generation of modulation symbols for the voice rate set.

### Example of Puncturing/Modulation for 6.5 kHz

FIG. 17 illustrates an example of modulation numerology for a Voice Rate Set with 6.5 kHz assignment. The encoder output bits may be punctured as follows:
For the 80 bit packet, c(2,k) and c(3,k) are punctured for each k=0, . . . ,99.
For the 40 bit packet, none of c(0,k), c(1,k), c(2,k) and c(3,k) are punctured for any k.
For the 60 bit packet: for k=0 . . . 74,
   If (k mod 3=0), then none of c(0,k), c(1,k), c(2,k) and c(3,k) are punctured.
   If (k mod 3=1), then c(2,k) and c(3,k) are punctured.
   If (k mod 3=2), then c(0,k) and c(1,k) are punctured.
Hence ⅔ of the input bits have 2 output bits, while ⅓ of the input bits have 4 output bits.

The punctured encoder output bits are grouped to form QPSK modulation symbols as described below. QPSK(c₀, c₁) is shorthand for the following:

QPSK(c₀,c₁)=(1−2c₀)+i(1−2c₁).
80 bit packet: For m=0, . . . ,M+Z−1, define
   c(m)=QPSK(c(0,m), c(1,m)).
There are 100 modulation symbols
40 bit packet: For m=0, . . . ,M+Z−1, define
   c(2m)=QPSK(c(0,m), c(1,m)).
   c(2m+1)=QPSK(c(2,m), c(3,m)).
This produces 2*50=100 modulation symbols.
60 bit packet: For m=0, . . . ,M+Z−1, let n=floor(m/3). Then define
   c(4n)=QPSK(c(0,3n), c(1,3n)),
   c(4n+1)=QPSK(c(2,3n), c(3,3n)),
   c(4n+2)=QPSK(c(0,3n+1), c(1,3n+1)),
   c(4n+3)=QPSK(c(2,3n+2), c(3,3n+2)).
This produces 4/3*75=100 modulation symbols.

### Example Puncturing/Repetition/Modulation for 13 kHz

FIG. 18 illustrates an example of modulation numerology for a Voice Rate Set with 13 kHz assignment. The encoder output bits are punctured as follows:
For the 80 bit packet, none of c(0,k), c(1,k), c(2,k) and c(3,k) are punctured for any k.
For the 40 bit packet, none of c(0,k), c(1,k), c(2,k) and c(3,k) are punctured for any k.
For the 60 bit packet, none of c(0,k), c(1,k), c(2,k) and c(3,k) are punctured for any k.
   The punctured encoder output bits are grouped to form QPSK modulation symbols as described below. QPSK(c₀, c₁) is shorthand for the following:

QPSK(c₀,c₁)=(1−2c₀)+i(1−2c₁).
80 bit packet: For m=0, . . . ,M+Z−1, define
   c(2m)=QPSK(c(0, m), c(1,m)).
   c(2m+1)=QPSK(c(2,m), c(3,m)).
There are 200 modulation symbols
40 bit packet: For m=0, . . . ,M+Z−1, define
   c(4m)=QPSK(c(0,m), c(1,m)).
   c(4m+1)=c(4m).
   c(4m+2)=QPSK(c(2,m), c(3,m)).
   c(4m+3)=c(4m+2).
This produces 4*50=200 modulation symbols. Note that c(4m) is repeated in c(4m+1), and c(4m+2) is repeated in c(4m+3).
60 bit packet: For m=0, . . . ,M+Z−1, let n=floor(m/3). Then define
   c(8n)=QPSK(c(0,3n), c(1,3n)),
   c(8n+1)=c(8n)
   c(8n+2)=QPSK(c(2,3n), c(3,3n)),
   c(8n+3)=QPSK(c(0,3n+1), c(1,3n+1)),
   c(8n+4)=QPSK(c(2,3n+1), c(3,3n+1)),
   c(8n+5)=c(8n+4).
   c(8n+6)=QPSK(c(0,3n+2), c(1,3n+2)),
   c(8n+7)=QPSK(c(2,3n+2), c(3,3n+2)),
This produces 8/3*75=200 modulation symbols. Note that c(8n) and c(8n+4) are each repeated.

### Puncturing/Repetition/Modulation for 26 kHz

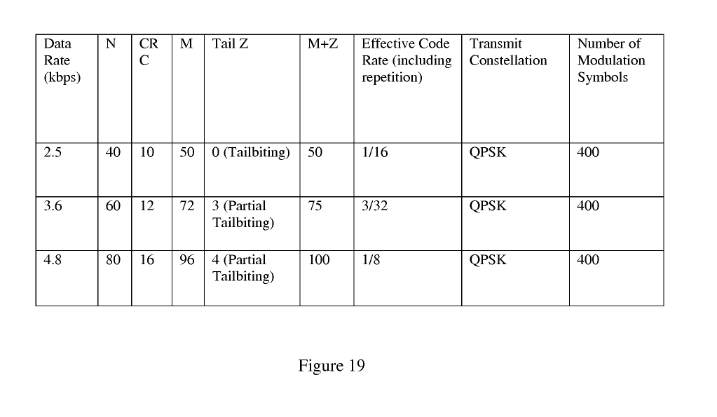

FIG. 19 illustrates an example of modulation numerology for a Voice Rate Set with 26 kHz assignment. The encoder output bits are punctured as follows:
For the 80 bit packet, none of c(0,k), c(1,k), c(2,k) and c(3,k) are punctured for any k.
For the 40 bit packet, none of c(0,k), c(1,k), c(2,k) and c(3,k) are punctured for any k.
For the 60 bit packet, none of c(0,k), c(1,k), c(2,k) and c(3,k) are punctured for any k.

The punctured encoder output bits are grouped to form QPSK modulation symbols as described below. QPSK(c₀, c₁) is shorthand for the following:

QPSK(c₀, c₁)=(1−2c₀)+i(1−2c₁).
80 bit packet: For m=0, . . . ,M+Z−1, define
   c(4m)=QPSK(c(0, m), c(1,m)).
   c(4m+1)=c(4m)
   c(4m+2)=QPSK(c(2,m), c(3,m)).
   c(4m+3)=c(4m+2).
There are 400 modulation symbols
40 bit packet: For m=, . . . ,M+Z−1, define
c(8m)=QPSK(c(0,m), c(1,m)).
c(8m+1)=c(8m).
c(8m+2)=c(8m).
c(8m+3)=c(8m).
c(8m+4)=QPSK(c(2,m), c(3,m)).
c(8m+5)=c(8m+4).
c(8m+6)=c(8m+4).
c(8m+7)=c(8m+4).
This produces 8*50=400 modulation symbols.
60 bit packet: For each m=0, . . . ,M+Z−1, let n=floor(m/3). Then define
   c(8n)=QPSK(c(0,3n), c(1,3n)).
   c(8n+1)=c(8n).
   c(8n+2)=c(8n).
   c(8n+3)=QPSK(c(2,3n), c(3,3n)).
   c(8n+4)=c(8n+3).
   c(8n+5)=c(8n+3).
   c(8n+6)=QPSK(c(0,3n+1), c(1,3n+1)).
   c(8n+7)=c(8n+6).
   c(8n+8)=QPSK(c(2,3n+1), c(3,3n+1)).
   c(8n+9)=c(8n+8).
   c(8n+10)=c(8n+8).
   c(8n+11)=QPSK(c(0,3n+2), c(1,3n+2)).
   c(8n+12)=c(8n+11).
   c(8n+13)=c(8n+11)
   c(8n+14)=QPSK(c(2,3n+2), c(3,3n+2)),
   c(8n+15)=c(8n+14).
This produces 16/3*75=400 modulation symbols.

One or more of the components, steps, and/or functions illustrated in FIGS. 1-19 may be rearranged and/or combined into a single component, step, or function or embodied in several components, steps, or functions without affecting the operation of the network helper for authenticating between the token and verifier. Additional elements, components, steps, and/or functions may also be added without departing from the invention. The apparatus, devices, and/or components illustrated in FIGS. 1, 2, 8, and/or 10 may be configured to perform one or more of the methods, features, or steps described in FIGS. 3, 4, 5, 6, 7, 9, 11, and/or 12-19. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A mobile terminal comprising:
a wireless communication interface configured to communicate via a satellite relay; and
a processor coupled with the wireless communication interface, the processor configured to
obtain a voice signal;
digitize the voice signal into voice-over-IP (VoIP) packets;
synchronize a physical layer frame and a VoIP packet frame and align them with a known periodic time boundary, wherein the physical layer and VoIP packet frames are of different sizes; and
transmit the VoIP packets over a reverse link channel to the satellite.

2. The mobile terminal of claim 1, further comprising:
a vocoder that receives the voice signal and digitizes into the VoIP packets.

3. The mobile terminal of claim 1, wherein the processor is further configured to adjust a reverse link transmission rate to match a VoIP packet rate; and
operate the reverse link transmission channel to the satellite continuously.

4. The mobile terminal of claim 1, wherein the processor is further configured to disable physical layer retransmit requests on the reverse link channel.

5. The mobile terminal of claim 1, wherein the processor is further configured to
selectively apply a different channel code depending on the size of packets being transmitted.

6. The mobile terminal of claim 5, wherein a first code optimized for time sensitive payloads is used on payloads smaller than 128 bits and a different second code is used for payloads larger than or equal to 128 bits.

7. The mobile terminal of claim 1, wherein wireless communication interface is a modified Evolution-Data Optimize wireless communication interface.

8. A method for communicating from a mobile terminal via a satellite relay, comprising:
obtaining a voice signal;
digitizing the voice signal into voice-over-IP (VoIP) packets;
synchronizing a physical layer frame and a VoIP packet frame and aligning them with a known periodic time boundary, wherein the physical layer and VoIP packet frames are of different sizes; and
transmitting the VoIP packets over a reverse link channel to the satellite.

9. The method of claim 8, further comprising:
adjusting a reverse link transmission rate to match a VoIP packet rate; and
operating the reverse link transmission channel to the satellite continuously.

10. The method of claim 8, further comprising:
disabling physical layer retransmit requests on the reverse link channel.

11. The method of claim 8, further comprising:
selectively applying a different channel code depending on the size of packets being transmitted.

12. The method of claim 11, wherein a first code optimized for time sensitive payloads is used on payloads smaller than 128 bits and a different second code is used for payloads larger than or equal to 128 bits.

13. The method of claim 8, further comprising:
selectively applying a different channel code depending on the type of packets being transmitted.

14. The method of claim 13, wherein a zero-overhead tailbiting convolutional code is used for the VoIP packets.

15. The method of claim 8, further comprising:
adjusting one or more time out periods in a communication protocol to account for the longer propagation delay over the satellite relay.

16. The method of claim 8, further comprising:
providing an indication to a recipient that VoIP packets are to be transmitted.

17. The method of claim 8, wherein the VoIP packets are transmitted over a modified Evolution-Data Optimize wireless communication interface.

18. The method of claim 8, further comprising:
providing an audible indication to the user that assist a user of the mobile terminal in orienting the mobile terminal to improve forward link signal reception from the satellite.

19. The method of claim 8, the reverse link comprises a Spread Spectrum Access Channel.

20. The method of claim 8, wherein the reverse link comprises flexible assignment of frequency channels.

21. The method of claim 8, wherein the reverse link comprises a rate set optimized for voice and for data.

22. The method of claim 8, wherein the reverse link operates as a broadband reverse link waveform.

23. The method of claim 8, wherein the reverse link operates as a narrowband reverse link waveform.

24. The method of claim 8, wherein the reverse link carries Channel Quality Indicator symbols generated using a bi-orthogonal code.

25. The method of claim 8, wherein the reverse link uses a partial tailbiting convolutional code as the reverse link channel code for the VoIP packets.

26. A mobile terminal comprising:
means for obtaining a voice signal;
means for digitizing the voice signal into voice-over-IP (VoIP) packets;
means for synchronizing a physical layer frame and a VoIP packet frame;
means for aligning the physical layer frame and a VoIP packet frame with a known periodic time boundary, wherein the physical layer and VoIP packet frames are of different sizes; and
means for transmitting the VoIP packets over a reverse link channel.

27. The mobile terminal of claim 26, further comprising:
means for adjusting a reverse link transmission rate to match a VoIP packet rate; and
means for transmitting over the reverse link transmission channel continuously.

28. The mobile terminal of claim 26, further comprising:
means for disabling physical layer retransmit requests on the reverse link channel.

29. The mobile terminal of claim 26, further comprising:
means for selectively applying a different channel code depending on the type of packets being transmitted.

30. The mobile terminal of claim 26, further comprising:
means for adjusting one or more time out periods in a communication protocol to account for the longer propagation delay over a satellite relay.

31. A processor readable medium having one or more instructions for facilitating voice-over-IP communications, which when executed by a processor causes the processor to:
digitize a voice signal into voice-over-IP (VoIP) packets;
synchronize a physical layer frame and a VoIP packet frame and align them with a known periodic time boundary, wherein the physical layer and VoIP packet frames are of different sizes; and
transmit the VoIP packets over a reverse link channel.

32. The processor readable medium of claim 31, further having one or more instructions which when executed by a processor causes the processor to:
adjust a reverse link transmission rate to match a VoIP packet rate; and
transmit over the reverse link transmission channel continuously.

33. The processor readable medium of claim 31, further having one or more instructions which when executed by a processor causes the processor to:
disable physical layer retransmit requests on the reverse link channel.

34. The processor readable medium of claim 31, further having one or more instructions which when executed by a processor causes the processor to:
selectively apply a different channel code depending on the type of packets being transmitted.

35. The processor readable medium of claim 31, further having one or more instructions which when executed by a processor causes the processor to:
adjust one or more time out periods in a communication protocol to account for the longer propagation delay over a satellite relay.

36. A processor comprising:
a processing circuit configured to digitize a voice signal into voice-over-IP (VoIP) packets;
synchronize a physical layer frame and a VoIP packet frame and align them with a known periodic time boundary, wherein the physical layer and VoIP packet frames are of different sizes; and
transmit the VoIP packets over a reverse link channel.

37. The processor of claim 36, wherein the processing circuit is further configured to:
adjust a reverse link transmission rate to match a VoIP packet rate; and
transmit over the reverse link transmission channel continuously.

38. The processor of claim 36, wherein the processing circuit is further configured to:
disable physical layer retransmit requests on the reverse link channel.

39. The processor of claim 36, wherein the processing circuit is further configured to:
selectively apply a different channel code depending on the type of packets being transmitted.

40. The processor of claim 36, wherein the processing circuit is further configured to:
adjust one or more time out periods in a communication protocol to account for the longer propagation delay over a satellite relay.

41. A gateway for receiving voice-over-IP communications via a satellite relay, comprising:
a wireless communication interface configured to communicate via a satellite relay; and
a processor coupled with the wireless communication interface, the processor configured to
adjust a reverse link transmission rate to match a VoIP packet source rate and receive VoIP packets on the reverse link continuously; and
receive VoIP packet frames that are smaller than physical layer frames, wherein a starting VoIP packet frame and a starting physical layer frame are synchronized and aligned to a known periodic time boundary, and the physical layer and VoIP packet frames are of different sizes.

42. The gateway of claim 41, wherein the processor is further configured to
receive an indication that VoIP packets will be received from the reverse link via the satellite relay.

43. The gateway of claim 41, wherein the processor is further configured to
disable physical layer retransmit requests on the reverse link channel.

44. The gateway of claim 41, wherein the processor is further configured to
selectively use a different channel coding to receive on the reverse link channel depending on the type of packets being received.

45. The gateway of claim 44, wherein a first code optimized for time sensitive payloads is used on payloads smaller than 128 bits and a different second code is used for payloads larger than or equal to 128 bits.

46. The gateway of claim 41, wherein wireless communication interface is a modified Evolution-Data Optimize wireless communication interface.

47. A method for facilitating voice-over-IP communications from a gateway via a satellite relay, comprising:
adjusting a reverse link transmission rate to match a VoIP packet source rate and receive VoIP packets on the reverse link continuously; and
receiving VoIP packet frames that are smaller than physical layer frames, wherein a starting VoIP packet frame and a starting physical layer frame are synchronized and aligned to a known periodic time boundary, and the physical layer and VoIP packet frames are of different sizes.

48. The method of claim 47, further comprising:
receiving an indication that VoIP packets will be received from the reverse link via a satellite.

49. The method of claim 47, further comprising:
disabling physical layer retransmission requests.

50. The method of claim 47, further comprising:
selectively using a different channel coding to receive on the reverse link channel depending on the type of packets being received.

51. The method of claim 47, further comprising:
adjusting one or more time out periods in a communication protocol to account for the longer propagation delay over the satellite relay.

52. The method of claim 47, further comprising: wherein the VoIP packets are received via a modified Evolution-Data Optimize (EVDO) wireless communication interface.

53. A gateway for receiving voice-over-IP communications via a satellite relay, comprising:
means for adjusting a reverse link transmission rate to match a VoIP packet source rate and receive VoIP packets on the reverse link continuously; and
means for receiving VoIP packet frames that are smaller than physical layer frames, wherein a starting VoIP packet frame and a starting physical layer frame are synchronized and aligned to a known periodic time boundary, and the physical layer and VoIP packet frames are of different sizes.

54. The gateway of claim 53, further comprising:
means for receiving an indication that VoIP packets will be received from the reverse link via a satellite.

55. The gateway of claim 53, further comprising:
means for disabling physical layer retransmission requests.

56. The gateway of claim 53, further comprising:
means for selectively using a different channel coding to receive on the reverse link channel depending on the type of packets being received.

57. The gateway of claim 53, further comprising:
means for adjusting one or more time out periods in a communication protocol to account for the longer propagation delay over the satellite relay.

58. A processor readable medium having one or more instructions for facilitating voice-over-IP communications, which when executed by a processor causes the processor to:
adjust a reverse link transmission rate to match a VoIP packet source rate and receive VoIP packets on the reverse link continuously; and
receive VoIP packet frames that are smaller than physical layer frames, wherein a starting VoIP packet frame and a starting physical layer frame are synchronized and aligned to a known periodic time boundary, and the physical layer and VoIP packet frames are of different sizes.

59. The processor readable medium of claim 58, further having one or more instructions which when executed by a processor causes the processor to:
receive an indication that VoIP packets will be received from the reverse link via a satellite.

60. The processor readable medium of claim 58, further having one or more instructions which when executed by a processor causes the processor to:
disable physical layer retransmission requests.

61. The processor readable medium of claim 58, further having one or more instructions which when executed by a processor causes the processor to:
selectively use a different channel coding to receive on the reverse link channel depending on the type of packets being received.

62. The processor readable medium of claim 58, further having one or more instructions which when executed by a processor causes the processor to:
adjust one or more time out periods in a communication protocol to account for the longer propagation delay over the satellite relay.

63. A processor comprising:
a processing circuit configured to
adjust a reverse link transmission rate to match a VoIP packet source rate and receive VoIP packets on the reverse link continuously; and
receive VoIP packet frames that are smaller than physical layer frames, wherein a starting VoIP packet frame and a starting physical layer frame are synchronized and aligned to a known periodic time boundary, and the physical layer and VoIP packet frames are of different sizes.

64. The processor of claim 63, wherein the processor is further configured to
disable physical layer retransmission requests.

65. The processor of claim 63, wherein the processor is further configured to
selectively use a different channel coding to receive on the reverse link channel depending on the type of packets being received.

66. The processor of claim 63, wherein the processor is further configured to
adjust one or more time out periods in a communication protocol to account for the longer propagation delay over the satellite relay.
